(19) United States
(12) Patent Application Publication
(10) Pub. No.: US 2007/0261785 A1
(43) Pub. Date: Nov. 15, 2007

(54) Polymerizable composition and method for producing (METH) acrylic thermally conductive sheet

(75) Inventors: Jun Izumi, Sayama-shi (JP); Masayuki Takada, Sayama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SOKEN CHEMICAL & ENGINEERING CO., LTD., Toshima-ku (JP)

(21) Appl. No.: 11/431,835

(22) Filed: May 11, 2006

(51) Int. Cl. C08L 33/00

(52) U.S. Cl. 156/272.2; 524/556; 525/244

(57) ABSTRACT

A polymerizable composition which contains a component (A): a (meth)acrylic monomer, a component (B): a (meth)acrylic polymer having at least one functional group capable of undergoing a cross-linking reaction in its molecule, a component (C): a (meth)acrylic oligomer having at one terminal of its molecule a functional group capable of undergoing a cross-linking reaction, a component (D): a cross-linking agent having a functional group capable of undergoing a cross-linking reaction, a compound (E): a photopolymerization initiator and/or a thermal polymerization initiator, and a component (F): a thermally conductive filler, is disclosed. Further, a (meth)acrylic thermally conductive sheet having a pressure-sensitive adhesive layer prepared by polymerizing and cross-linking the polymerizable composition on a support is disclosed. The thermally conductive sheet prepared by using the polymerizable composition according to the invention is excellent in flexibility, adhesiveness and bleed resistance and can dissipate heat generated from a heat-generating body such as an electronic device with good efficiency.

### TECHNICAL FIELD

The present invention relates to a polymerizable composition and a (meth)acrylic thermally conductive sheet utilizing the polymerizable composition and, more particularly, to a polymerizable composition capable of forming a pressure-sensitive adhesive having excellent flexibility even after polymerization, even though it contains a thermally conductive filler and a thermally conductive sheet having flexibility to be used in electronic parts and the like.

### BACKGROUND ART

Along with a trend toward high density and size reduction of electronic devices or the like, it has become an important problem to efficiently dissipate heat generated from these electronic devices and, as a measure for solving this problem, a thermally conductive sheet containing a thermally conductive particle has been bonded to a heat-generating part or the like so that the thus-generated heat is dissipated.

As a pressure-sensitive adhesive for the thermally conductive sheet, a methacrylic or an acrylic (hereinafter, referred to “(meth)acrylic” for short) polymer has widely been used, since it has excellent pressure-sensitive adhesive properties. However, there is a problem in that, since the thermally conductive sheet using this pressure-sensitive adhesive contains a large amount of thermally conductive filler, it is inferior in flexibility.

In order to solve this problem, a method of using an acrylic polyurethane resin as a binder thereof is known (see JP-A No. 2002-030212); however, even by this method, the flexibility has not satisfactorily been imparted.

Further, another method in which a plasticizing effect is imparted by dispersing a compound which is insoluble with the polymer and which has a relatively low melting point in the system for improvement of the flexibility is known (see JP-A No. 2003-105299); however, there is a problem in that such dispersed substance having a low melting point seeps outside the system while in use.

Then, a (meth)acrylic thermally conductive sheet which has flexibility even though it contains a thermally conductive filler and is, also, excellent in an adhesive property and does not have seepage of plasticizer or the like, that is, excellent in an bleed resistance, and a polymerizable composition to be used for such sheet are desired.

### DISCLOSURE OF THE INVENTION

In order to solve these problems, the present inventors have exerted intensive studies and found that, at the time of preparing a (meth)acrylic polymer, by using a polymerizable composition containing a (meth)acrylic oligomer having a functional group at one terminal of a molecule thereof, a thermally conductive sheet which is excellent in flexibility and is, also, excellent in an bleed resistance can be obtained and so have achieved the present invention.

Namely, the invention provides a polymerizable composition which contains at least components (A) to (F):

(A) a (meth)acrylic monomer;

(B) a (meth)acrylic polymer having at least one functional group capable of undergoing a cross-linking reaction in a molecule thereof;

(C) a (meth)acrylic oligomer having at one terminal of its molecule a terminal functional group capable of undergoing a cross-linking reaction;

(D) a cross-linking agent;

(E) a photopolymerization initiator and/or a thermal polymerization initiator; and

(F) a thermally conductive filler.

Further, the invention provides a (meth)acrylic thermally conductive sheet containing a pressure-sensitive adhesive layer prepared by polymerizing and cross-linking the above polymerizable composition on a support.

### BEST MODE FOR CARRYING OUT THE INVENTION

The term “(meth)acrylic monomer”, which is component (A) according to the present invention means an acrylic monomer or a methacrylic monomer having only one (co)polymerizable double bond in its molecule. Such (meth)acrylic monomers include those having a functional group capable of undergoing a cross-linking reaction such as a hydroxyl group or a carboxyl group and those having no such functional group.

Among them, the (meth)acrylic monomer having no functional group which is used as the component (A) is not particularly limited. Specific examples of such (meth)acrylic monomers include (meth)acrylic acid alkyl esters such as methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, and dodecyl (meth)acrylate; (meth)acrylic acid esters such as cyclohexyl (meth)acrylate, benzyl (meth)acrylate, phenyl ethyl (meth)acrylate, phenoxyethyl (meth)acrylate, and phenoxydiethylene glycol ester (meth)acrylate; and (meth)acrylic acid aryl esters such as phenyl (meth)acrylate, and methyl phenyl (meth)acrylate. These (meth)acrylic esters can be used alone, or two or more of them may be used in combination. Preferably, acrylic acid alkyl esters are used and, particularly preferably, butyl acrylate or 2-ethylhexyl acrylate are used.

Further, the (meth)acrylic monomer having a functional group capable of undergoing a cross-linking reaction which is used as component (A) according to the invention also is not particularly limited. Specific examples of such (meth)acrylic monomers include monomers having a carboxyl group such as (meth)acrylic acid; monomers having a hydroxyl group such as 2-hydroxyethyl(meth)acrylate, 3-hydroxypropyl(meth)acrylate and 4-hydroxybutyl(meth)acrylate; monomers having an aziridine group such as (meth)acryloyl aziridine and 2-aziridinyl ethyl(meth)acrylate; monomers having an epoxy group such as (meth)acryloyl glycidyl and (meth)acryloyl 2-ethylglycidyl ether; monomers having an amide group such as (meth)acrylamide, N-methylol(meth)acrylamide, N-methoxyethyl(meth)acrylamide, N-butoxymethyl(meth)acrylamide and dimethylaminomethyl(meth)acrylate; and monomers having an isocyanate group such as 2-(meth)acryloyloxyethyl isocyanate.

These (meth)acrylic monomers having a functional group are not necessarily used. However, since they react with a component (C) as described below and thus impart the polymer with flexibility, or, they provide component (D), which is the cross-linking agent of a polymer to be generated by light irradiation or heating, with a cross-linking point, it is preferable to blend them. Particularly preferable monomers are (meth)acrylic acid and 2-hydroxyethyl(meth)acrylate.

The amount of the methacrylic monomer having a functional group to be blended based on the total mass of the component (A) is preferably from 0.01 to 20% by mass and, particularly preferably, from 1 to 10% by mass.

A (meth)acrylic polymer in which a component (B) according to the invention contains at least one functional group capable of undergoing a cross-linking reaction in its molecule is a polymer combining a (meth)acrylic monomer having at least one functional group capable of undergoing a cross-linking reaction and a (meth)acrylic monomer having no functional group, and has at least one functional group in its molecule.

Specific examples of such (meth)acrylic monomers having a functional group and such (meth)acrylic monomers having no functional group for use in preparation of the component (B) are same monomers as those in a case of the component (A). The amount of (meth)acrylic monomer having a functional group copolymerized in the component (B) is preferably from 0.01 to 20% bymass and, particularly preferably, from 1 to 10% bymass.

The molecular weight of the component (B) is not particularly limited but is, in terms of weight average molecular weight, preferably 50,000 or more, more preferably from 100,000 to 1,000,000 and, particularly preferably, from 150,000 to 500,000.

The number of the functional groups contained in the component (B) is one or more. The functional group in the component (B) can be a reaction site for a component (C) to be described below and can be a cross-linking site for a component (D). In view of preferable polymerization ratio and preferable molecular weight of the (meth)acrylic monomer having the functional group as described above, the number of the functional groups to be contained in the component (B) is preferably in the range of from 10 to 1000.

The component (B) may be separately synthesized ahead of time and may be mixed with other components of the invention, or may be used in the form of a partially polymerized material. Namely, by bulk polymerizing a (meth)acrylic monomer at a polymerization ratio of from 5 to 90% by mass and, particularly preferably, from 15 to 70% by mass, a solution in which the component (B) is dissolved in the component (A) is obtained and, then, the thus-obtained solution can be mixed with other components. At the time of such bulk polymerization, a chain transfer agent can be added for adjusting the polymerization ratio.

Vinyl compounds other than the (meth)acrylic monomer, such as styrene, α-methylstyrene, vinyl toluene, vinyl acetate and allyl acetate may be copolymerized in the component (B)

Further, the component (C) is a (meth)acrylic oligomer having a terminal functional group capable of undergoing a cross-linking reaction. A structure and a production method thereof are not particularly limited. As for the component (C), for example, an oligomer which is obtained by terminating polymerization of the (meth)acrylic monomer at an appropriate point by using a compound having a group which causes chain transfer and a functional group in its molecule is mentioned. Examples of such compounds each having a group which causes chain transfer and a functional group in its molecule include 2-mercaptoethanol and β-mercaptopropionic acid. The number of functional groups capable of undergoing a cross-linking reaction at one terminal of the molecule is not particularly limited, but is preferably from 1 to 2 and, particularly preferably, one.

A molecular weight of the component (C) is not particularly limited and is preferably 20000 or less, more preferably 10000 or less and, particularly preferably, from 2000 to 7000.

As for specific examples of the component (C), commercially available articles such as UMB-1001 (trade name; produced by Soken Chemical & Engineering Co., Ltd.) may be chosen and can be used.

The component (D), a cross-linking agent, is a compound which has two or more functional groups in its molecule and which can cross-link the component (B) and/or a polymer including the component (A) or the like, or can react with the component (C), by light irradiation and/or heating. On this occasion, the functional groups are not particularly limited, but are preferably a vinyl group, a carboxyl group, an epoxy group, an isocyanate group, a hydroxyl group and the like. The component (D) can contain two or more functional groups of same type in a molecule thereof or two or more functional groups of two or more different types in its molecule.

Further, the component (D) is not particularly limited, but a multifunctional monomer, an epoxy type cross-linking agent, an isocyanate type cross-linking agent, glycidyl methacrylate, 2-methacryloxyethyl isocyanate and the like may be chosen.

The multifunctional monomer is not particularly limited so long as it is a compound which has two or more (co)polymerizable double bonds with a (meth)acrylate group, an allyl group, a vinyl group or the like in a molecule thereof and also is radically polymerizable. Specific examples of such multifunctional monomers include 1,4-butanediol di(meth)acrylate, 1,6-hexanediol di(meth)acrylate, 1,9-nonanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, pentaerythritol tetra(meth)acrylate, trimethylolpropane di(meth)acrylate, trimethylolpropane tri(meth)acrylate, allyl(meth)acrylate, vinyl(meth)acrylate, polyester(meth)acrylate, and urethane(meth)acrylate. These multifunctional monomers may be used alone, or two or more of them can be used in combination.

Further, the epoxy type cross-linking agent is not particularly limited so long as it is a compound having two or more epoxy groups in a molecule thereof. Specific examples of such epoxy type cross-linking agents include a bisphenol A epichlorohydrin type epoxy resin, ethylene glycidyl ether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidylamine, N,N,N′,N′-tetraglycidyl-m-xylylenediamine, and 1,3-bis(N,N′-diamine glycidylaminomethyl)cyclohexane. These epoxy type cross-linking agents may be used alone, or two or more of them can be used in combination.

Meanwhile, the isocyanate type cross-linking agent is not particularly limited so long as it is a compound having two or more isocyanate groups in a molecule thereof. Specific examples of such isocyanate type cross-linking agents include tolylene diisocyanate, hexamethylene diisocyanate, isophorone diisocyanate, xylylene diisocyanate, hydrogenated xylylene diisocyanate, diphenyl methane diisocyanate, hydrogenated diphenyl methane diisocyanate, tetramethyl xylylene diisocyanate, naphthalene diisocyanate, triphenyl methane triisocyanate, polymethylene polyphenyl isocyanate and an adduct of a polyol such as trimethylol propane to any one of these isocyanates. These isocyanates maybe used alone, or two or more of them can be used in combination.

In the components (A) to (D), the functional group capable of undergoing the cross-linking reaction contained in each of their molecules is not particularly limited, but is preferably a vinyl group, a carboxyl group, an epoxy group, an isocyanate group or a hydroxyl group.

Further, the component (E) is a photopolymerization initiator and/or a thermal polymerization initiator. Among these initiators, the photopolymerization initiator is not particularly limited. Specific examples of such photopolymerization initiators include acyl phosphine oxides such as 2,4,6-trimethylbenzoyl diphenyl phosphine oxide (trade name: Lucirin TPO; produced by BASF Aktiengesellshaft) and 2,4,6-trimethylbenzoyl phenyl ethoxyphosphine oxide (trade name: Lucirin TPO-L; produced by BASF Aktiengesellshaft); aminoketones such as 2-benzyl-2-dimethylamino-1-(4-morpholinophenyl)-butanone-1 (trade name: IRGACURE® 369; produced by Ciba Specialty Chemicals Inc.); bis-acyl phosphine oxides such as bis (2,4,6-trimethylbenzoyl)-phenyl phosphine oxide (trade name: IRGACURE® 819; produced by Ciba Specialty Chemicals Inc.), and bis(2,6-dimethoxybenzoyl)-2,4,4-trimethylpentyl phosphine oxide (trade name: CGI403; produced by Ciba Specialty Chemicals Inc.); hydroxyketones such as hydroxycyclohexyl phenyl ketone (trade name: IRGACURE® 184; produced by Ciba Specialty Chemicals Inc.), and hydroxy-2-methyl-1-phenyl-propane-1-one (trade name: Darocure 1173; produced by Ciba Specialty Chemicals Inc.); benzophenones such as benzophenone, 2,4,6-trimethyl benzophenone, and 4-methylbenzophenone; benzyl methyl ketal (trade name: Esacure KBI; available from Nihon SiberHegner K.K.); and a 2-hydroxy-2-methyl-[4-(1-methylvinyl)phenyl]propanol oligomer (trade name: Esacure KIP 150; available from Nihon SiberHegner K.K.).

Further, the thermal polymerization initiator is not particularly limited so long as it is ordinarily used in thermal polymerization of the (meth)acrylic monomer, and specific examples of such thermal polymerization initiators include azo type thermal polymerization initiators such as 4,4′-azobis(4-cyanovaleric acid), dimethyl 2,2′-azobis(2-methyl propionate), 2,2′-azobis(4-methoxy-2,4-dimethyl valeronitrile), 2,2′-azobis(2,4-dimethyl valeronitrile), 2,2′-azobis(2-methyl propionitrile), 2,2′-azobis(2-methyl butyronitrile), 1,1′-azobis(cyclohexane-1-carbonitrile), and 1-[(1-cyano-1-methyl ethyl)azo]formamide; peroxide type thermal polymerization initiators such as cumyl hydroperoxide, cumyl peroxyneodecanoate, cyclohexanone peroxide, 1,1,3,3-tetramethyl butyl peroxyneodecanate, octanoyl peroxide, lauroyl peroxide, 3,5,5-trimethyl hexanoyl peroxide, benzoyl peroxide, t-butyl perpivalate, t-butyl peroxy-2-ethylhexanoate, t-butyl peroxyisobutyrate, t-butyl cumyl peroxide, t-butyl peroxyneoheptanoate, 1,1-bis(t-hexyl peroxy)cyclohexane, diisopropyl peroxydicarbonate, and 3-chloroperbenzoic acid. Among these thermal polymerization initiators, peroxide type thermal polymerization initiators are preferable and, therein, t-butyl perpivalate is more preferable.

Lastly, the component (F) according to the invention is a thermally conductive filler. The component (F) is not particularly limited so long as it can impart thermal conductivity required for the thermally conductive sheet according to the invention. Specific examples of such thermally conductive fillers include aluminum hydroxide, magnesium hydroxide, calcium carbonate, magnesium carbonate, calcium silicate, magnesium silicate, calcium oxide, magnesium oxide, zinc oxide, aluminum oxide, crystalline silica, amorphous silica, titanium oxide, nickel oxide, iron oxide, copper oxide, aluminum nitride, boron nitride, silicon nitride, carbon, graphite, silicon nitride, and aluminum borate whisker. Among these thermally conductive fillers, aluminum hydroxide and aluminum oxide are preferable.

The component (F) is contained in the polymerizable composition according to the invention in form of particles. A diameter of such particle is not particularly limited, but is preferably from 1 to 100 μm.

Contents of the components (A) to (F) in the preparation of the polymerizable composition according to the invention are not particularly limited, but the weight ratio of component (B) to the sum of the component (A) and the component (B) is preferably in the range from 5 to 90% by mass, and particularly preferably from 15 to 70% by mass. The preferable ranges of the component (C) and the component (F) are described below based on the 100 parts by mass (hereinafter, referred to simply as “parts”) of the sum of the component (A) and the component (B).

| | Preferable range | Particularly preferable range |
|---|---|---|
| Component (C) | 2 to 50 parts | 5 to 20 parts |
| Component (D) | 0.01 to 2 parts | 0.05 to 1 part |
| Component (E) | 0.01 to 5 parts | 0.05 to 2 parts |
| Component (F) | 50 to 300 parts | 100 to 250 parts |

When the amount of the component (C) to be blended is smaller than the above ranges, an effect of flexibility can not be obtained, while, when it is larger than the above ranges, strength of the thermally conductive sheet is remarkably reduced and required pressure-sensitive adhesive properties thereof can not be developed.

When the amount of the component (D) is unduly small, tack develops and not only does handling of the thermally conductive sheet deteriorate, but also the thermally conductive sheet tends to be softened by heating and, then, hard for it to keep its shape, while, when it is unduly large, the thermally conductive sheet is hardened and loses flexibility.

Further, when the amount of the component (E) is unduly small, the polymerization ratio does not increase, and there is sometimes an odor caused by remaining unreacted (meth)acrylic type monomer. When the amount of the component (E) is unduly large, not only is no further effect obtained, but instead there is a case in which the molecular weight of the polymer obtained by light irradiation and/or heating comes to be unduly small.

Further, when the amount of the component (F) is unduly small, the thermal conductivity sometimes comes to be deteriorated and, accordingly, when the thermally conductive sheet is prepared, a heat dissipation effect sometimes cannot be obtained. On the other hand, when the amount of the component (F) is unduly large, not only is no further improvement of the thermal conductivity obtained, but instead viscosity of the polymerizable composition is remarkably increased, and there is a case in which a problem is generated at the time of applying it on the support.

In the polymerizable composition according to the invention, as an optional component, other (co)polymerizable monomers than the (meth)acrylic monomer, a tackifier resin, a flame retardant, an additive and the like can be blended.

Examples of (co)polymerizable monomers other than (meth)acrylic monomers include styrene type monomers such as styrene, α-methyl styrene, and vinyl toluene; vinyl acetate; allyl acetate; monomers each containing a carboxyl group such as itaconic acid, crotonic acid, maleic anhydride, and fumaric acid; monomers each containing an oxazoline group such as 2-vinyl-2-oxazoline, 2-vinyl-5-methyl-2-oxazoline, and 2-isopropenyl-2-oxazoline; monomers containing an epoxy group such as allyl glycidyl ether; monomers each having a double bond between carbons such as monomers each containing an organic silicic group such as vinyl trimethoxysilane, γ-methacryloxypropyl trimethoxy silane, allyl trimethoxysilane, trimethoxysilyl propyl allyl amine, and 2-methoxyethoxytrimethoxy silane.

Further, the tackifier resin is not particularly limited, and for example an alicyclic petroleum resin, a dicyclopentadiene type hydrogenated petroleum resin, an aliphatic hydrogenated petroleum resin, and a hydrogenated terpene resin may be chosen. Examples of such alicyclic petroleum resins include Arcon P series (for example, Arcon P-70, Arcon P-90, Arcon P-100, Arcon P-125, and Arcon P-140), Arcon M series (trade names; produced by Arakawa Chemical Industry Co., Ltd.), Rigalite 90, Rigalite R-100, and Rigalite R-125 (trade names; produced by Rika-Hercules Inc.). Examples of such dicyclopentadiene type hydrogenated petroleum resins include Escorez 5000 series (for example, Escorez ECR-299D, Escorez ECR-228B, Escorez ECR-143H, Escorez ECR-327 (trade names; produced by Tonex Co., Ltd.)), and Aimarb (trade name; produced by Idemitsu Petrochemical Co., Ltd.). Examples of such aliphatic hydrogenated petroleum resins include Marukarez H (trade name; produced by Maruzen Petrochemical Co., Ltd.). Examples of such hydrogenated terpene resins include Clearon P, M, and K series (produced by Yasuhara Chemical Co., Ltd.). These tackifier resins can each be added up to an extent which does not disturb the photoradical polymerization.

Further, the flame retardant is not particularly limited. Examples of such flame retardants include halogen type flame retardants such as tetrabromobisphenol A, decabromodiphenyl oxide, octabromodiphenyl ether, hexabromocyclododecane, bistribromophenoxyethane, tribromophenol, ethylenebistetrabromophthalimide, a tetrabromobisphenol A-epoxy oligomer, brominated polystyrene, ethylene bispentabromodiphenyl, chlorinated paraffin, and dodecachlorocyclooctane; and phosphorus type flame retardants such as phosphoric acid compounds, polyphosphoric acid compounds, and red phosphorus compounds. Among these flame retardants, from the standpoint of loads to be put on the environment and human bodies, the non-halogenated types are preferred. These flame retardants may be used either in a powder state or a liquid state and may be used alone, or two or more of them can be used in combination.

Further, additives such as a thickening agent, a dye, a pigment, and an antioxidant may be chosen.

Although the polymerizable composition according to the invention has the thermal conductivity, it is excellent in flexibility and is also excellent in bleed resistance, and thus can be used, for example, for a core material for a two-sided pressure-sensitive adhesive tape, a damping material, or a ceiling material. However, in order to exploit the advantageous feature of the polymerizable composition according to the invention, it is particularly preferably utilized in a thermally conductive sheet.

One illustrative example of a method for producing a thermally conductive sheet utilizing the polymerizable composition according to the invention is a production method containing the steps of applying the polymerizable composition according to the invention on a support in a thickness of from 0.5 mm to 10 mm, laminating a protective sheet on the surface of the thus-applied layer as necessary, and forming a pressure-sensitive adhesive layer by polymerizing the polymerizable composition of the resultant laminate with light irradiation and/or heating. On this occasion, the light irradiation may be performed either from one side or both sides and is, preferably, performed from both sides.

The support or the protective sheet to be used in producing the thermally conductive sheet according to the invention is not particularly limited, and specific examples of such supports or protective sheets include polyethylene terephthalate, polyethylene, polypropylene and an ethylene vinyl acetate copolymer. These films may previously be treated with surface processing such as processing for improving peeling properties.

Thickness of the polymerizable composition according to the invention to be applied on the support is, preferably, from 0.5 mm to 10 mm and, particularly preferably, from 0.5 mm to 2 mm.

Further, the light source to be used for the light irradiation is not particularly limited and examples of such light sources include a chemical lamp, a black light lamp, a low-pressure mercury lamp, a high-pressure mercury lamp, an ultrahigh-pressure mercury lamp and a metal halide lamp.

The (meth)acrylic thermally conductive sheet according to the invention is bonded to a face of one heat-generating body or heat dissipating body and, after the support is removed therefrom, the (meth)acrylic thermally conductive sheet according to the invention is further bonded to a face of the other heat-generating body or heat dissipating body and, then, used.

In the polymerizable composition according to the invention, the component (C) is introduced into a molecular skeleton of a main polymer by a chemical reaction caused either by being polymerized by the light irradiation or via the component (D). Due to such introduction, the thermally conductive sheet excellent in bleed resistance and having flexibility can be obtained.

### EXAMPLES

Hereinafter, examples are given to illustrate the invention and should not be interpreted as limiting it in any way. “% by mass” and “parts by mass” are referred to as “%” and “parts” for short, respectively.

<Preparation of Component (B) (Preparation of Partially Polymerized Article)>

### Production Example 1

920 g of 2-ethylhexyl acrylate (hereinafter, referred to as “2-EHA” for short), 80 g of acrylic acid (hereinafter, referred to as “AA” for short), and 0.6 g of n-dodecylmercaptan were put in a 2-liter four-necked flask equipped with an agitator, a thermometer, a nitrogen gas inlet tube and a condenser and, then, heated to 60° C. while replacing the air inside the flask with a nitrogen gas.

Subsequently, 0.025 g of 2,2′-azobis(4-methoxy-2,4-dimethylvaleronitrile) (trade name: V-70; produced by Wako Pure Chemical Industries, Ltd.) (hereinafter, referred to as “V-70” for short) was added as a polymerization initiator to the resultant mixture under agitation and, then, homogeneously mixed. After the polymerization initiator was added, a temperature of a reaction system rose. However, when the polymerization reaction was allowed to advance without cooling, the temperature of the reaction system reached 120° C. and, then, started to gradually fall. When the temperature of the reaction system was decreased to 115° C., the mixture was forcibly cooled, to thereby obtain a solution (hereinafter, referred to as “partially polymerized material AB-1”) in which the (meth)acrylic polymer was dissolved in the (meth)acrylic monomer. In the thus-obtained partially polymerized material AB-1, (meth)acrylic monomer concentration was 67%; (meth)acrylic polymer concentration was 33%; and the weight average molecular weight of the polymer portion was 210,000.

### Production Example 2

950 g of 2-EHA, 50 g of 2-hydroxyethyl acrylate (hereinafter, referred to as “2HEA” for short), and 0.6 g of n-dodecylmercaptan were put in a 2-liter four-necked flask equipped with an agitator, a thermometer, a nitrogen gas inlet tube and a condenser and, then, heated to 60° C. while replacing the air inside the flask with a nitrogen gas.

Subsequently, 0.025 g of V-70 was added as a polymerization initiator to the resultant mixture under agitation and, then, homogeneously mixed. After the polymerization initiator was added, a temperature of a reaction system rose. However, when the polymerization reaction was allowed to advance without cooling, the temperature of the reaction system reached 115° C. and, then, started to gradually fall. When the temperature of the reaction system was decreased to 110° C., the mixture was forcibly cooled, to thereby obtain a solution (hereinafter, referred to as “partially polymerized material AB-2”) in which the (meth)acrylic polymer was dissolved in the (meth)acrylic monomer. In the thus-obtained partially polymerized material AB-2, (meth)acrylic monomer concentration was 70%; a (meth)acrylic polymer concentration was 30%; and the weight average molecular weight of the polymer portion was 180,000.

<Preparation of Component (C)>

### Production Example 3

1000 g of 2-EHA, and 0.05 g of zirconocene dichloride (hereinafter, referred to as “ZrC” for short) were put in a 2-liter four-necked flask equipped with an agitator, a thermometer, a nitrogen gas inlet tube and a condenser and, then, heated to 95° C. while replacing the air inside the flask with a nitrogen gas.

Subsequently, 37 g of β-mercaptopropionic acid (hereinafter, referred to as “BMPA” for short) was added to the resultant mixture under agitation and, then, homogeneously mixed. After BMPA was added, the temperature of the reaction system rose, so the system was cooled while allowing the polymerization reaction to advance. 2 hours after BMPA was added, 0.1 g of 2,2′-azobis(2-methylpropionitrile) (trade name: AIBN; produced by Otsuka Pharmaceutical Co., Ltd.) (hereinafter, referred to as “AIBN” for short) was added as a polymerization initiator to the mixture under agitation and, then, homogeneously mixed. After the polymerization initiator was added, the temperature of the reaction system rose, so the system was cooled while allowing the polymerization reaction to advance. After one more hour, 0.5 g of AIBN was added to the mixture under agitation and, then, homogeneously mixed. 5 hours after the BMPA was added, the mixture was forcibly cooled, to thereby obtain a (meth)acrylic oligomer (hereinafter, referred to as “oligomer C-1”). In the thus-obtained oligomer C-1, polymer concentration was 99%; and the weight average molecular weight of a polymer portion thereof was 6000.

### Production Example 4

1000 g of the oligomer C-1 obtained in Production Example 3, 0.2 g of 4-methoxyhydroquinone (hereinafter, referred to as “MEHQ” for short), and 29 g of glycidyl methacrylate (hereinafter, referred to as “GMA” for short) were put in a 2-liter four-necked flask equipped with an agitator, a thermometer, a nitrogen gas inlet tube and a condenser and, then, heated to 95° C. without replacing the air inside the flask with a nitrogen gas.

Subsequently, 10 g of triethyl amine (hereinafter, referred to as “TEA” for short) was added to the resultant mixture under agitation and, then, homogeneously mixed. Thereafter, the temperature inside the flask was kept at 95° C. 5 hours after TEA was added, the mixture was forcibly cooled, to thereby obtain a (meth)acrylic oligomer (hereinafter, referred to as “oligomer C-2”). In the thus-obtained (meth)acrylic oligomer C-2, polymer concentration was 98%; and the weight average molecular weight of a polymer portion thereof was 6000.

### Production Example 5

1000 g of 2-EHA, and 0.05 g of ZrC were put in a 2-liter four-necked flask equipped with an agitator, a thermometer, a nitrogen gas inlet tube and a condenser and, then, heated to 95° C. while replacing the air inside the flask with a nitrogen gas.

Subsequently, 40 g of 2-mercaptoethanol (hereinafter, referred to as “2ME” for short) was added to the resultant mixture under agitation and, then, homogeneously mixed. After 2ME was added, the temperature of a reaction system rose, so the system was cooled as the polymerization reaction was allowed to advance. 2 hours after 2ME was added, 0.1 g of AIBM was added as a polymerization initiator to the mixture under agitation and, then, homogeneously mixed. After the polymerization initiator was added, the temperature of the reaction system rose, so the system was cooled as the polymerization reaction was allowed to advance. After one more hour, 0.5 g of AIBM was added to the mixture under agitation and, then, homogeneously mixed. 5 hours after 2ME was added, the mixture was forcibly cooled, to thereby obtain a (meth)acrylic oligomer (hereinafter, referred to as “oligomer C-3”). In the thus-obtained oligomer C-3, a polymer concentration was 98%; and a weight average molecular weight of the polymer portion was 4000.

<Production of (Meth)acrylic Thermally Conductive Sheet>

### Example 1

Based on 100 parts of the partially polymerized material AB-1 obtained in Production Example 1, 10 parts of the oligomer C-1 obtained in Production Example 3, 200 parts of aluminum hydroxide powder (trade mark: HIGILITE® H-42; produced by Showa Denko K.K.) (hereinafter, referred to as “H-42”), 0.1 part of TETRAD-X (trade name; produced by Mitsubishi Gas Chemical Co., Inc.) (hereinafter, referred to as “T-X”) as an epoxy cross-linking agent, and 0.5 part of IRGACURE® 819 (trade name; produced by Ciba Specialty Chemicals Inc.) (hereinafter, referred to as “I819”) were added to 100 parts of the partially polymerized material AB-1 and, then, mixed while performing defoaming at room temperature, to thereby obtain a polymerizable composition.

Subsequently, after the polymerizable composition was applied in a thickness of 1 mm by using a doctor blade on a silicone-coated transparent PET film separator which has a thickness of 100 μm, the same type of transparent PET film separator was laminated on the surface of the thus-applied composition in order to block it from contacting air and, then, the resultant laminate was irradiated by using a high-pressure mercury lamp for 10 minutes, to obtain a (meth)acrylic thermally conductive sheet a.

### Example 2

A (meth)acrylic thermally conductive sheet b was obtained in a same manner as in Example 1 except that the oligomer C-2 obtained in Production Example 4 was used in place of the oligomer C-1.

### Example 3

A (meth)acrylic thermally conductive sheet c was obtained in a same manner as in Example 1 except that the oligomer C-3 obtained in Production Example 5 was used in place of the oligomer C-1, and 0.01 part of 2-methacryloyloxyethyl isocyanate (trade name: KARENZ® MOI; produced by Showa Denko K.K.) was added as a cross-linking agent.

### Example 4

Based on 100 parts of the partially polymerized material AB-2 obtained in Production Example 2, 10 parts of the oligomer C-3 obtained in Production Example 5, 200 parts of H-42 as a thermally conductive filler, 0.3 part of TPA-100 (trade name; produced by Asahi Kasei Corporation) as an isocyanate type cross-linking agent, 0.5 part of I819 as a photopolymerization initiator were added to 100 parts by mass of the partially polymerized article and, then, mixed while performing defoaming at room temperature, to thereby obtain a polymerizable composition.

Subsequently, after the polymerizable composition was applied in a thickness of 1 mm by using a doctor blade on a silicone-coated transparent PET film separator which has a thickness of 100 μm, the same type of transparent PET film separator was laminated on the surface of the thus-applied composition in order to block it from contacting air and, then the resultant laminate was irradiated by using a high-pressure mercury lamp for 10 minutes, to obtain a (meth)acrylic thermally conductive sheet d.

### Reference Example 1

A (meth)acrylic thermally conductive sheet e-1 was obtained in the same manner as in Example 1 except that the oligomer C-1 was not added.

### Reference Example 2

A (meth)acrylic thermally conductive sheet e-2 was obtained in the same manner as in Example 1 except that 150 parts of the oligomer C-1 was added.

### Reference Example 3

A (meth)acrylic thermally conductive sheet e-3 was obtained in the same manner as in Example 1 except that the oligomer C-1 was not added and, instead, 10 parts of dioctyl phthalate was added as a plasticizer.

### Reference Example 4

A (meth)acrylic thermally conductive sheet e-4 was obtained in the same manner as in Example 1 except that the epoxy type cross-linking agent T-X was not added.

### Reference Example 5

A (meth)acrylic thermally conductive sheet e-5 was obtained in a same manner as in Example 1 except that 5 parts of the epoxy type cross-linking agent T-X was added.

### TEST EXAMPLES

Evaluation of (Meth)acrylic Thermally Conductive Sheet:

(Meth)acrylic thermally conductive sheets obtained in Examples 1 to 4 and Reference Examples 1 to 4 were evaluated in accordance with methods described below. The results are shown in Table 1.

Bleeding Resistance

A filter paper having a thickness of 250 μm was laminated to either face of each sheet which was 50 mm long×50 mm wide, and the resultant laminate was left to stand with a load of 5 kg thereon for 3 days in an atmosphere of 100° C. and, then, the wetness of the filter paper was observed. When the filter paper was dry, it was marked as “O”, while, when leak into the filter paper was observed, it was marked as “X”.

Asker C Hardness

The sheets were laminated with one another so that a resultant sheet had a thickness of 10 mm and, then, hardness of the resultant sheet was measured by using an Asker C-type hardness meter under conditions of 23° C./65% RH (reference conditions set by JIS Z 0237).

Adhesive Strength

After an aluminum foil having a thickness of 50 μm was laminated on one face of a sheet 25 mm wide×150 mm long, the other face of the sheet was attached to an aluminum test piece and, then, left to stand for 30 minutes at 23° C./65% RH and, thereafter, a 90° peel strength of the sheet was measured by using a tension tester (trade name: Strograph M1; manufactured by Toyo Seiki Seisaku-sho, Ltd.).

Holding Power

After an aluminum foil having 50 mm long×25 mm wide×200 μm thick was laminated on one face of a sheet 25 mm long×25 mm wide, the other face of the sheet was attached to an aluminum test piece. The resultant laminate was placed in a dehydrator in which temperature was adjusted to be 80° C. and, then, left to stand therein for one hour and, thereafter, a load of 1 kg was applied. One hour after such application of the load, a distance of dislocation of the sheet or a period of time until the sheet was dropped was measured.

TABLE 1

| | Thermally | Bleed | | Adhesive | |
|---|---|---|---|---|---|
| | conductive | resis- | Asker C | strength | |
| No. | sheet | tance | hardness | (g/cm) | Holding power |
| Example 1 | a | ◯ | 43 | 350 | |
| Example 2 | b | ◯ | 40 | 400 | Displacement: |
| | | | | | 0 mm |
| Example 3 | c | ◯ | 45 | 380 | Displacement: |
| | | | | | 0 mm |
| Example 4 | d | ◯ | 45 | 300 | Displacement: |
| | | | | | 0 mm |
| Reference | e-1 | ◯ | 75 | 200 | Displacement: |
| Example 1 | | | | | 0 mm |
| Reference | e-2 | X | 25 | 190 | Dropped in |
| Example 2 | | | | | one minute |
| Reference | e-3 | X | 48 | 300 | Displacement: |
| Example 3 | | | | | 0 mm |
| Reference | e-4 | X | 10 | Incapable | Incapable of |
| Example 4 | | | | of mea- | measurement* |
| | | | | surement* | |
| Reference | e-5 | ◯ | 86 | 100 | Dropped in |
| Example 5 | | | | | one minute |

*since strength of the thermally conductive sheet was remarkably reduced, it was impossible to treat the thermally conductive sheet as a sheet having a pressure-sensitive adhesive property.

A shown in Table 1, the (meth)acrylic thermally conductive sheet using the polymerizable composition according to the invention was excellent in all of the bleed resistance, the Asker C hardness, the adhesive strength and the holding power.

### INDUSTRIAL APPLICABILITY

Although a polymerized material prepared by polymerizing the polymerizable composition according to the present invention contains a large amount of thermally conductive filler, it has flexibility and is excellent in adhesive properties such as hardness, adhesive strength, and holding power and is also excellent in bleed resistance.

Therefore, the polymerizable composition according to the invention can be used not only for production of a (meth)acrylic thermally conductive sheet to be used for dissipating heat of an electronic device or the like but also for various types of applications such as a core material for a two-sided pressure-sensitive adhesive tape, a damping material, and a ceiling material.

Further, since the thermally conductive sheet produced by using the polymerizable composition according to the invention is excellent in flexibility, adhesiveness and bleed resistance, it can effectively dissipate heat generated from the heat-generating body such as the electronic device, and therefore, the thermally conductive sheet can widely be utilized in electric and electronic fields.

1. A polymerizable composition, being characterized by comprising at least components (A) to (F):
(A) a (meth)acrylic monomer;
(B) a (meth)acrylic polymer having at least one functional group capable of undergoing a cross-linking reaction in its molecule;
(C) a (meth)acrylic oligomer having at one terminal of its molecule a functional group capable of undergoing a cross-linking reaction;
(D) a cross-linking agent having a functional group capable of undergoing a cross-linking reaction;
(E) a photopolymerization initiator and/or a thermal polymerization initiator; and
(F) a thermally conductive filler.

2. The polymerizable composition according to claim 1, wherein the weight average molecular weight of the component (B) is 50,000 or more.

3. The polymerizable composition according to claim 1 or 2, wherein the weight average molecular weight of the component (C) is 10,000 or less.

4. The polymerizable composition according to any one of claims 1 to 3, wherein the functional group capable of undergoing a cross-linking reaction is a vinyl group, a carboxyl group, an epoxy group, an isocyanate group, or a hydroxyl group.

5. The polymerizable composition according to any one of claims 1 to 4, comprising the component (C) in an amount of from 2 to 50 parts by mass based on 100 parts by mass of the sum of the component (A) and the component (B).

6. The polymerizable composition according to any one of claims 1 to 5, comprising the component (D) in an amount of from 0.01 to 2 parts by mass based on 100 parts by mass of the sum of the component (A) and the component (B).

7. A (meth)acrylic thermally conductive sheet, comprising a pressure-sensitive adhesive layer prepared by polymerizing and cross-linking the polymerizable composition according to any one of claims 1 to 6.

8. A method for producing a (meth)acrylic thermally conductive sheet, being characterized by comprising applying the polymerizable composition according to any one of claims 1 to 6 in a thickness of from 0.5 to 10 mm on a support, laminating a protective sheet on the surface of the thus-applied composition and, then subjecting the resultant laminate to light irradiation and/or heating.
